(19) United States
(12) Patent Application Publication
(10) Pub. No.: US 2018/0023883 A1
(43) Pub. Date: Jan. 25, 2018

(54) HOUSEHOLD COOLING APPLIANCE CONTAINING A DISPENSER UNIT FOR LIQUID AND/OR FREE FLOW REFRIGERATED GOOD, WHICH CONTAINS A DRIP ELEMENT FOR LIQUID ON A COVER

(71) Applicant: BSH HAUSGERAETE GMBH, MUENCHEN (DE)

(72) Inventors: VOLKAN CAKIRCA, ISTANBUL (TR); MEHMET CIYANOGLU, ISTANBUL (TR); TANZER YILDIZGOECER, TEKIRDAG (TR)

(21) Appl. No.: 15/652,297

(22) Filed: Jul. 18, 2017

(30) Foreign Application Priority Data
Jul. 19, 2016 (TR) 2016/09933

(51) Int. Cl. F25D 23/12; B67D 1/16; B67D 1/08; F25D 29/00; F25D 23/02

(52) U.S. Cl. CPC F25D 23/126; F25D 29/005; F25D 23/028; B67D 1/0894; B67D 1/16

(57) ABSTRACT

A household cooling appliance has a dispenser unit for dispensing a liquid and/or a free flow refrigerated good. The dispenser unit has an insert with side walls and a bottom wall bounding a niche, into which a receptacle for receiving the liquid and/or the free flow refrigerated good, is inserted. The dispenser unit has a drip tray for containing liquid that is brought into the niche. The drip tray has a drip well. A cover covers the side walls towards the niche, and is arranged within the niche. On a front side of the cover facing the niche is disposed a drain element, which is configured to be elevated towards the niche and for draining a liquid running into the drip tray. The drain element is arranged in a height direction above the drip tray or in the bottom wall a slot is formed for draining liquid from the insert.

### CROSS-REFERENCE TO RELATED APPLICATION

This application claims the priority, under 35 U.S.C. §119, of Turkish application TR 2016/09933, filed Jul. 19, 2016; the prior application is herewith incorporated by reference in its entirety.

### BACKGROUND OF THE INVENTION

### Field of the Invention

The invention relates to a household cooling appliance having a dispenser unit for dispensing a liquid and/or free flow refrigerated good, which has an insert, which by side walls and a bottom wall bounds a niche, into which a receptacle can be inserted for receiving the liquid and/or free flow refrigerated good to be dispensed. The appliance further has a drip tray that is separate from the insert for containing liquid that can be brought into the niche by dripping or draining, wherein the drip tray contains a drip well.

Household cooling appliances for storing and preserving food items are known from the prior art. It is also known that in such appliances in a door closing a receiving space for food a dispenser unit or an output unit of the liquid and/or free flow refrigerated good, such as for instance ice cubes or crushed ice, is configured. Also with the door being closed thus dispensing of this liquid or this free flow refrigerated good is facilitated. For instance from international patent disclosure WO 2009/080635 A2 (corresponding to U.S. Pat. No. 8,966,927) a corresponding dispenser unit is known.

Moreover from international patent disclosure WO 2007/118787 A1, corresponding to U.S. Pat. No. 8,122,734, a household cooling appliance containing a corresponding dispenser device is known. In this design moreover on a front side of the door an additional decorative plate, which is separate therefrom, for instance a furniture front plate, is arranged. This furniture front plate contains a hole or a recess, through which the dispenser unit or a niche of this dispenser unit is also accessible. The dispenser unit in this design is also attached to this decorative plate.

Moreover, from international patent disclosure WO 2009/110674 A1 a corresponding output unit is known, which additionally also has an electronics module. This electronics module has control elements and moreover also has a display unit. Further, a separate drip tray can be inserted there into the niche. The drip tray, however, is only put up on a bottom side and is magnetically held on the rear portion on a rear wall. The drip tray has a grid, which is integrated as cover.

In the known embodiments liquid, which in the niche reaches the walls bounding the niches, for instance by spilling from a receiving vessel or by splashing water, can run past the drip tray in an undesired way. Thereby this liquid can be contained only insufficiently and/or can reach areas, in which components of the household cooling appliance are contaminated or impaired as to their function.

### SUMMARY OF THE INVENTION

It is the task of the present invention to provide a household cooling appliance, in which liquid occurring in the niche and reaching the walls bounding the niche, can be drained into a drip tray in the niche in an improved way.

It is the task of the present invention to provide a household cooling appliance, in which the draining of liquid from an insert forming the niche is improved so that an undesired collecting of this liquid in a bottom area of this insert is avoided.

These tasks are solved by household cooling appliances, which have the features of the independent patent claims.

According to a first independent aspect of the invention a household cooling appliance having a dispenser unit for dispensing a liquid and/or free flow refrigerated good is configured. The dispenser unit, which can also be referred to as output unit, has an insert, which by vertical side walls and a bottom wall bounds a niche. This niche is freely accessible at the front side and into this niche a collection container or a receiving vessel for receiving the liquid and/or the free flow refrigerated good dispensed by the dispenser unit can be brought in. The dispenser unit moreover has a drip tray, which is separate from the insert and which can be inserted for containing liquid, which can be brought into the niche. This bringing liquid into the niche can be affected by way of dripping or draining. For instance this can happen by liquid spilling over the drip tray, because it has not been emptied. Moreover, also splashing water can occur, which then reaches these walls. For instance this can also occur, when a free flow refrigerated good, such as ice cubes or crushed ice drops outside the drip tray and then melts. Equally, such an undesired liquid can then occur, if the dispensing of liquid and/or free flow refrigerated good is not yet completed, but a user already previously removes the receiving vessel inserted into the niche.

An essential idea of the invention is to be seen in that the dispenser unit has a cover that is separate from the insert and is arranged within the niche. The cover is arranged and configured in such a way that side walls of the in particular box-shaped or tray-like insert at least partly are covered towards the niche. On a front side of the cover facing the niche and thus on a front side of the cover, which faces away from a side wall of the insert, a liquid draining element elevated towards the niche, which is configured for draining a liquid running from the front side of the cover into the drip tray, is arranged. This draining element, viewed in the height direction of the dispenser unit and thus also in the height direction of the niche, is arranged above the drip tray. By such a drain element in a specific and defined way it can be achieved that undesired liquid occurring in the niche nevertheless can be drained into the drip tray.

Preferably it is envisaged that the drain element is configured to be hump-like and in the vertical section comprises a wave shape. By this specific geometry the drain behavior of the liquid from the front side of the cover into the drip tray is enhanced. Thereby no undesired abrupt slowing down of liquid running or dripping from the front side is caused so that here in turn the liquid then is not stopped in an undesired way by this drain element and then would spread again as splash water into the niche. Rather, by this geometry of the drain element on the one hand a certain slowing down of the liquid running from the front side is achieved, on the other hand, however, a further continuous draining process of this liquid downwards with specifically pre-determined direction is promoted. On the other hand, by this specific shape of the drain element, however, then in a specific way, in particular at the highest point of the drain element, a release of the liquid from the drain element is achieved so that the liquid then, however, can arrive in the drip tray also in a specific way.

Preferably it is envisaged that the drain element is orientated in the width direction of the niche. The drain element thus is configured as an elongated structure, which extends in this width direction. Thus across this horizontal direction a drain element can be configured as comprehensively as possible so that viewed in this width direction such uninterrupted drain aid is provided. Independently of the places in which viewed in the width direction liquid drains from the front side of the cover, then invariably also the drain element is present and supports the passing of the liquid into the drip tray.

Preferably it is envisaged that the drain element is configured to be straight-lined. This is a very simple and highly functional geometry, which is simple to manufacture and which promotes in particular the defined and specific draining of the liquid into the drip tray.

Preferably the drain element is configured to be integrated in the cover and thus integrally formed with the cover. Thereby, a design with a reduced number of components is provided and thus no further interfaces between the cover and the drain element are given. An undesired formation of a slot between the cover and the drain element, into which then again partly liquid could enter, is thereby avoided. Also, thus an interface between the cover and the drain element is avoided, through which the specific draining of the liquid into the drip tray could be influenced in a disadvantageous way.

Preferably, it is envisaged that in the bottom wall of the insert at least one slot for draining liquid from the insert is configured. This is a further very advantageous embodiment, because thereby particularly liquid that is present between the cover and the insert and then runs down into this clearance between the insert and the cover, can be drained from the insert in a directed way. Since this very liquid cannot reach the drip tray, as the cover quasi also forms a barrier between the insert and the drip tray, this liquid can collect under the drip tray, however still in the insert. Thereby, in this area a pollution might occur that is undesired. Also in this connection undesired smells can form, which can occur by liquid accumulating there over an extended period of time. In order to avoid this, too, by this at least one slot an immediate draining of such liquid from the insert is facilitated.

Preferably it is envisaged that the slot in the bottom wall of the insert and upward extends into a side wall of the insert adjacent to the bottom wall. A comprehensive draining of the liquid occurring in this regard is thereby improved.

Preferably it is envisaged that in the bottom wall several slots, in particular four slots, are configured. In particular the number of the slots can depend on the size of the bottom wall. In particular the number and geometry of the slots is designed to the effect that on the one hand a sufficient draining of corresponding liquid from the insert is achieved, on the other hand, however, a certain cover of the components arranged under the bottom wall is achieved. Thus it can also be avoided that then, if the drip tray is removed from the insert and thus then the slots are uncovered, a recognizing of components of the household cooling appliance arranged under the bottom wall of the insert from below is basically avoided. In this connection for instance cables or other lines can extend under the bottom wall, which then because of the correspondingly larger number of slots, which then however can be dimensioned smaller, can essentially not be recognized. Thus also a certain viewing protection is created, which in comparison with an embodiment, in which only one slot is present, which then would have to be of relatively large dimensions, is achieved.

Preferably it is envisaged that the slot narrows towards a front slot end, which faces away from a rear vertical side wall ending in the bottom wall. Such slot thus is preferably configured thinnest on a front slot end facing a niche opening.

This also means that this slot expands at the rear edge of the bottom wall. This is then in particular very advantageous, if the drip tray with its bottom wall is arranged preferably tilted relative to a horizontal plane and in particular quasi tilted towards the back. This means that the rear edge of the bottom wall is situated in a lower position than a front edge of this bottom wall that is situated closer to the niche opening. By such a design then the draining of liquid collecting on the bottom wall of the insert can be improved, as same then due to gravitation and the tilted position of the bottom wall is then automatically drained towards the back towards the slots and due to this geometry of the slots then also a comprehensive and immediate draining of the liquid from the insert can be achieved.

According to a further independent aspect of the invention a household cooling appliance having an output unit for dispensing a liquid and/or free flow refrigerated good is envisaged. The dispenser unit which can also be referred to as output unit has an insert, which by vertical side walls in a bottom wall bounds a niche. This in particular box-shaped insert is equally as in the first independent aspect of the invention formed as a single piece, for instance made of plastic, at least within the scope of these side walls and the bottom wall. By these side walls and the bottom wall a niche of the dispenser unit is bounded. This niche at the front side is freely accessible and into this niche a collection container or receiving vessel for receiving the liquid and/or free flow refrigerated good dispensed by the dispenser unit can be inserted. The dispenser unit moreover has a drip tray, which is separate from the insert and is configured for containing and collecting liquid that can be brought into the niche. The drip tray comprises a drip well. The collection of this undesired liquid into the niche outside collection container can occur due to the situations named already in the above.

An essential idea of this further independent aspect of the invention is to be seen in that in the bottom wall of the insert at least one slot for draining liquid from the insert downwards is configured. Thereby it can be avoided that liquid running past the drip tray into the insert, collects under the drip tray and the bottom wall of the insert and cannot drain therefrom. By these slots the immediate and specific draining of this liquid occurring in an undesired way is achieved. The undesired pollution and/or formation of smell due to the liquid, which would collect below the drip tray in the insert on the bottom wall, can thereby be avoided.

Embodiments of the first independent aspect of the invention are to be considered as advantageous embodiments of the second aspect of the invention and vice versa.

Preferably the household cooling appliance is a rack-mounted model. In particular it can be arranged in a furniture niche of a furniture wall.

With the indications “top”, “bottom”, “front”, “rear, “horizontal”, “vertical”, “depth direction”, “width direction”, “height direction” etc. the positions and orientations given for intended use and intended arrangement of the appliance and for a user then standing in front of the appliance and viewing in the direction of the device are indicated.

Further features of the invention derive from the claims, the figures, and the description of the figures. The aforementioned features and feature combinations named in the description, as well as the features and feature combinations named in the following in the description of the figures and/or shown in the figures alone can be used not only in the respective indicated combination, but also in other combinations, without departing from the scope of the invention. Thus also embodiments of the invention are to be considered as comprised and disclosed, which are not explicitly shown and explained in the figures, but by separated feature combinations derived from the explained embodiments and can be generated therefrom. Thus also explanations and feature combinations are to be regarded as disclosed, which thus do not comprise all features of an originally formulated independent claim. Moreover embodiments and feature combinations, in particular by the embodiments set out in the above, are to be considered as disclosed, which go beyond the feature combinations set out in the back-references of the claims or deviate therefrom.

Other features which are considered as characteristic for the invention are set forth in the appended claims.

Although the invention is illustrated and described herein as embodied in a household cooling appliance containing a dispenser unit for liquid and/or free flow refrigerated good, which contains a drip element for liquid on a cover, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective exploded view of an embodiment of a household cooling appliance according to the invention;

FIG. 2 is a perspective view of an insert of a dispenser unit, which is configured for dispensing liquid and/or free flow refrigerated good and forms part of the household cooling appliance according to FIG. 1;

FIG. 3 is a perspective partial view of the insert according to FIG. 2 in a portion of a bottom wall having slots formed in the bottom wall;

FIG. 4 is a perspective view of the insert according to FIG. 2 and FIG. 3 with a cover arranged additionally in a niche of the insert and separate therefrom;

FIG. 5 is a vertical sectional view of a partial portion taken along the line V-V shown in FIG. 4;

FIG. 6 is a schematic view of a partial portion in FIG. 5; and

FIG. 7 is an exploded, perspective view of the components according to FIG. 4.

### DETAILED DESCRIPTION OF THE INVENTION

In the figures same elements and elements having the same functions are equipped with the same reference signs.

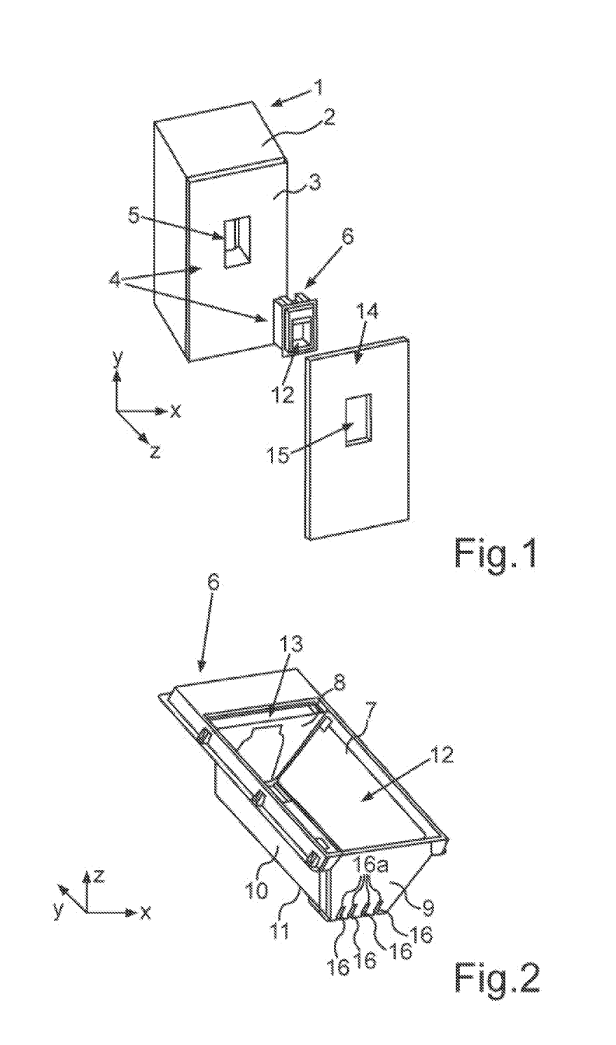

Referring now to the figures of the drawings in detail and first, particularly to FIG. 1 thereof, there is shown a schematic view of a household cooling appliance 1, which is configured for storing and preserving food, and which for instance can be a refrigerator appliance, a freezer, or a fridge/freezer combination device. The household cooling appliance 1 is in particular a rack-mounted model. The household cooling appliance 1 contains a housing 2, in which at least one receiving space for food is configured. The receiving space can be closed at the front side by a door 3, which is shown in FIG. 1 in a closed state and which is pivotably arranged on the housing 2. The household cooling appliance 1 contains an output unit or a dispenser unit 4, which in FIG. 1 is merely in an exemplary way equipped with reference signs, and in which in FIG. 1 individual components are shown only partly. The dispenser unit 4 is configured for dispensing a liquid and/or free flow refrigerated good. Thus, a drink and/or an ice cube form element, for instance an ice cube or crushed ice can be dispensed.

For this purpose in the shown embodiment for instance the door 3 contains a recess 5, in which the dispenser unit 4 is inserted so that in the closed state of the door 3 the dispenser unit 4 is accessible from the front in order to be capable of dispensing the liquid and/or the free flow refrigerated good.

The dispenser unit 4 has an insert 6, which in particular is formed as a single piece from plastic. The insert 6 contains several walls 7, 8, 9, 10, and 11 (FIG. 2), which bound a niche or recess 12. The recess or the niche 12 is configured for receiving or inserting a receiving vessel so that into this receiving vessel the liquid and/or the free flow refrigerated good can be brought in from the above. The niche 12 is accessible from the front. The dispenser unit 4 has a dispenser opening, which ends in particular in a niche ceiling wall 8 and via which the liquid and/or the free flow refrigerated good can be brought into the niche 12 and therein into the inserted receiving vessel.

This insert 6 moreover has in an exemplary way a receptacle 13, which is configured as a slot. Into the slot 13 an electronics module is insertable.

In FIG. 1 moreover also a decorative plate 14 is shown, which is separate from the door 3 and preferably present and which can be a furniture front plate. This decorative plate 14 is preferably attachable to the door 3 and covers same at the front side. Also the decorative plate 14 has a recess 15, through which the dispenser unit 6 is accessible at the front side. In particular the dispenser unit 4, in particular the insert 6, is arranged on the decorative plate 14, in particular fastened thereto.

In FIG. 2 the insert 6 is shown in a perspective view.

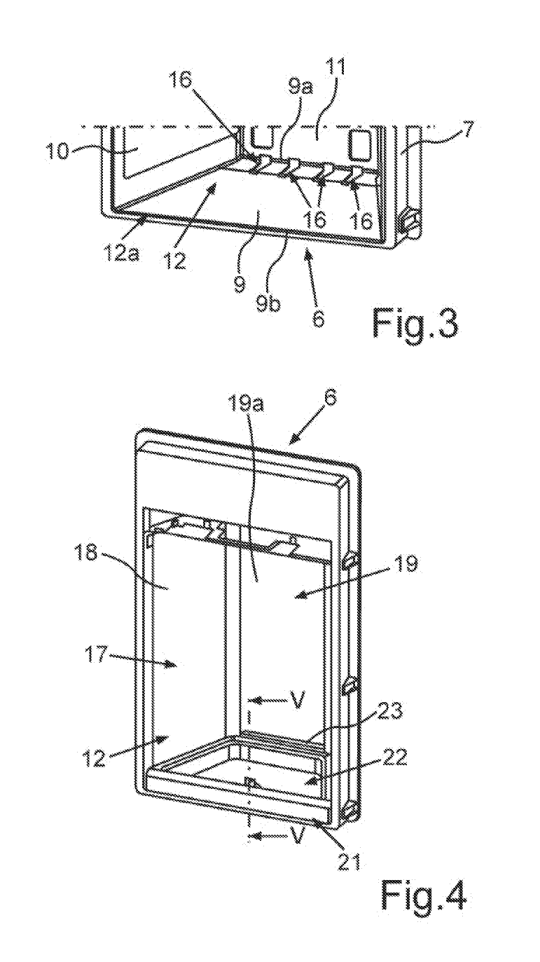

In FIG. 3 in a perspective view the insert 6 is shown in a bottom portion. As can be seen, in the shown embodiment in the bottom wall 9 there are several slots 16, which thus represent through-holes. In an exemplary way here a number of four slots 16 are provided. The slots 16 in the embodiment extend both in the bottom wall 9 as well as in the vertical side wall 11, which is adjacent to the bottom wall 9 and represents a rear wall. The slots 16 each are configured to be uninterrupted so that they also extend without interruption across the transition between the bottom wall 9 and the side wall configured as rear wall.

The slots 16 are arranged in the width direction and thus in the x direction spaced apart from each other. The slots 16 in their partial portion, in which they extend in the bottom wall 9, are configured to be narrowing. This means that they narrow from a rear edge 9a of the bottom wall 9 towards a front edge 9b of the bottom wall 9. Therefore at least one slot 16, especially all slots 16, narrows towards a front slot end 16a, which faces away from the side wall 11 ending in the bottom wall 9.

In particular it is envisaged in the embodiment that the bottom wall 9 is not arranged horizontally, and thus does not fully extend in the x-z plane, but in this regard is arranged to be tilted. In particular it is envisaged that the tilting is such that the rear edge 9a viewed in the height direction and thus in the y direction is situated lower than the front edge 9b. The front edge 9b is the edge that is arranged closer to a niche opening 12a of the niche 12 than the rear edge 9a.

As can also be seen in FIG. 2, the insert 6 is preferably integrally formed, in particular from plastic.

In FIG. 4 a perspective view is shown, in which the insert 6 is represented and moreover a cover 17, which is separate from and additional to the insert 6 and is preferably formed from metal and is in particular configured as a single piece, is positioned in the niche 12. The cover 17 is arranged in such a way that it covers the side walls 7, 10, and 11 on the front side and thus towards the niche 12 or at least essentially on the front side. The cover 17 therefore has a trapezium shape and has in particular three side walls 18, 19, and 20 (FIG. 7).

Moreover, in FIG. 4 a drip tray 21 is shown, which is configured as separate component from the cover 17 and also as separate component from the insert 6. The drip tray 21 is arranged in the bottom portion of the insert 6 within the niche 12 and preferably is rested on the bottom wall 9. The drip tray 21 has a drip well 22, which is open towards the top and in which liquid entering the niche 12 and not being received by a receiving vessel put up therein, such as a drinking glass or the like, can be collected. In particular it is envisaged that liquid dripping or running down from a front side 19a of the vertical side wall 19 of the cover 17, is also collected in the drip tray 21. The drip tray 21 is non-destructively releasable from the insert 6 and reinsertable.

In the inserted state of the drip tray 21 the slots 16 are covered from the above. Moreover they are also covered by the cover 17 so that they cannot be recognized according to the view in FIG. 4 when looking from the front into the niche 12.

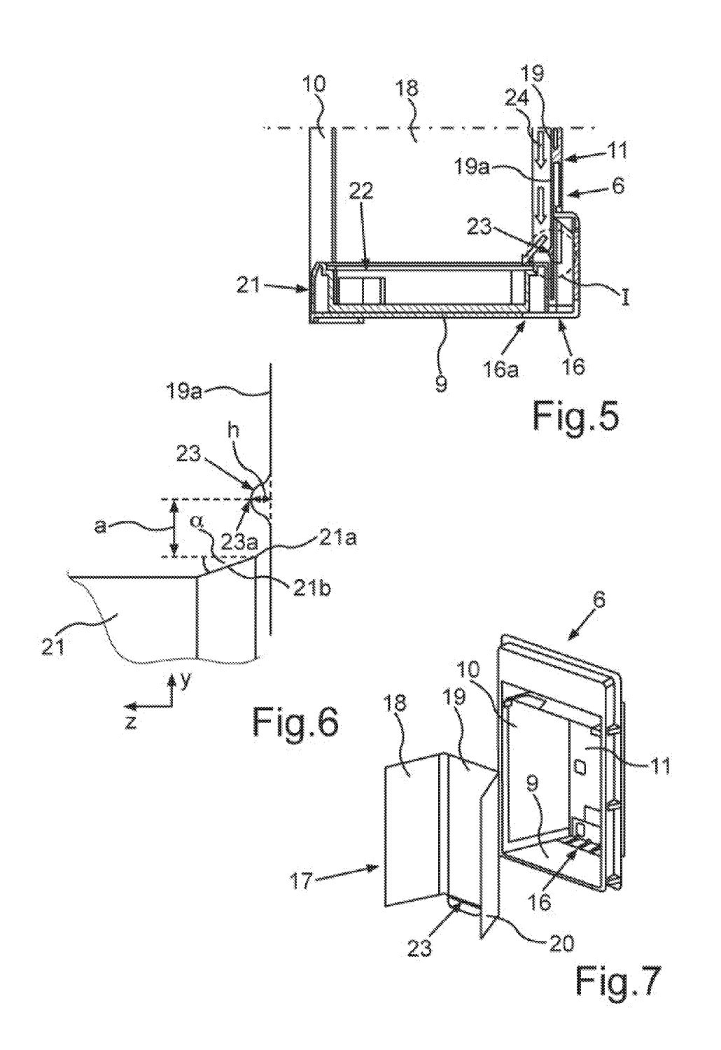

As is shown in FIG. 4, the cover 17 has at least one drain element 23, which preferably is integrated in the side wall 19 and thus is formed as a single piece. The drain element 23 preferably extends across the entire width of the side wall 19 representing a rear wall, and moreover is also preferably configured to be straight-lined. As can equally be seen in FIG. 4, the drain element 23, which is arranged to protrude elevated from the front side 19a towards the front into the niche 12, is situated in the height direction (y direction) above the drip tray 21, if same is arranged in its final position in the niche 12. Also a certain spacing of the drain element 23 from the drip tray 21 is configured, as this is also shown in the vertical sectional view in FIG. 5 showing a section along the section line V-V in FIG. 4. The liquid 24, which is shown in a symbolical way by arrows in FIG. 5 and which drips or runs from the front side 19a, then arrives at the drain element 23 and by its preferably hump-like design, which in the cross-section represents a wave shape, is drained in the direction of the drip tray 21 and then due to the draining speed and the shape design of the drain element 23 comes off the front side 19a and drips into the drip tray 21 and then in particular into the drip well 22. A running of this liquid 24 past the drip tray 21 between the front side 19a and the drip tray 21 is thereby prevented.

In FIG. 6 in a schematic view an enlarged view of the partial portion I in FIG. 5 is shown. Preferably, the drain element 23 has a height (h), which here is measured in the depth direction and thus in the z direction, which amounts to between 0.8 mm and 1.3 mm. This height (h) is drawn in FIG. 6.

Moreover, it is envisaged that a distance (a) measured in the height direction between a rear top edge 21a of the drip tray 21 and a height axis extending through the highest point 23a of the drain element 23, amounts to between 2.5 mm and 3 mm.

In an advantageous embodiment it is envisaged that this top portion of the drip tray 21, which faces the top drain element 23, has an outer and tilted lateral flange 21b, which declines from the outer edge or the top edge 21a towards the drip well 22, wherein here an angle α is formed that preferably amounts to between 3° and 10°, in particular between 4° and 6°.

Moreover it can also be seen that the drip tray 21 in its final position preferably is arranged in the niche 12 in such a way that in the depth direction and thus in the z direction in particular an overlapping between the drain element 23 and the drip tray 21 is formed. This generally means that this rear portion of the drip tray 21 and thus the top edge 21a is positioned further towards the back than a height maximum or the highest point 23a of the drain element 23. This is in particular also envisaged for all embodiments.

In FIG. 7 in an exploded view a design of the insert 6 and the cover 17, as it is configured in FIG. 4, is shown. The drip tray 21 is not shown in FIG. 7.

The cover 17 is attachable in a non-destructively releasable way on the insert 6 and detachable again, and in this connection can preferably be held by magnetic holding force.

In an advantageous way it is envisaged that the liquid running down between the cover 17 and the side walls 7, 10, and 11 of the insert 6 and due to the arrangement of the cover 17 then cannot reach the drip tray 21, is drainable via the slots 16 from the insert 6. This liquid then after leaving the insert 6 via the slots 16 via then present channels, which in particular are also cable channels, in which lines and cables can be installed, is drained further down. In particular then in the bottom portion of the door 3 a further drip tray for this liquid is formed, where it then preferably is evaporated by waste heat from the components in a machine space of the household cooling appliance 1. The machine space is preferably arranged in a bottom rear portion of the household cooling appliance 1 or the housing 2 and preferably has components of the cooling circuit. In particular therein a compressor can be arranged, the waste heat of which that is generated in operation then is used for evaporating also this liquid, which then is contained in this further named drip tray.

The following is a summary list of reference numerals and the corresponding structure used in the above description of the invention:
1 household cooling appliance
2 housing
3 door
4 dispenser unit
5 recess
6 insert
7 wall
niche ceiling wall
8 wall
9a rear edge
9b front edge
10 wall
11 wall
12 niche
12a niche opening
13 receptacle
14 decorative plate
15 recess
16 slot
16a front slot end
17 cover
18 side wall
19 side wall
19a front side
20 side wall
21 drip tray
21a top edge
21b side flange
22 drip well
23 drain element
23a highest point
24 liquid
a distance
h height
α angle

1. A household cooling appliance, comprising:
a dispenser unit for dispensing a liquid and/or a free flowing refrigerated good, said dispenser unit having:
an insert with side walls and a bottom wall bounding a niche;
a receptacle for receiving the liquid and/or the free flow refrigerated good being disposed in said niche, said receptacle having a drip tray, being separate from said insert for collecting the liquid that can be brought into said niche, said drip tray having a drip well formed therein;
a cover, being separate from said insert, covering said side walls at least partly towards said niche, said cover disposed in said niche and having a front side facing said niche; and
at least one drain element disposed on said front side facing said niche, said drain element configured to be elevated towards said niche and for draining the liquid running from said front side into said drip tray, said drain element in a height direction is disposed above said drip tray.

2. The household cooling appliance according to claim 1, wherein said drain element is configured to be hump-shaped and in cross-section has a wave shape.

3. The household cooling appliance according to claim 1, wherein said drain element is orientated in a width direction of said niche.

4. The household cooling appliance according to claim 1, wherein said drain element is configured to be straight-lined.

5. The household cooling appliance according to claim 1, wherein said drain element is integrated within said cover.

6. The household cooling appliance according to claim 1, wherein said bottom wall has at least one slot formed therein and said slot is configured for draining the liquid from said insert.

7. The household cooling appliance according to claim 6, wherein said slot extends in said bottom wall and upwards into one of said side walls adjacent to said bottom wall.

8. The household cooling appliance according to claim 6, wherein said slot formed in said bottom wall is one of a plurality of slots formed therein.

9. The household cooling appliance according to claim 6, wherein said slot narrows towards a front slot end, which faces away from one of said side walls ending in said bottom wall.

10. The household cooling appliance according to claim 6, wherein said slot formed in said bottom wall is one of four slots formed therein.

11. A household cooling appliance, comprising:
a dispenser unit for dispensing a liquid and/or a free flow good, said dispenser unit having:
an insert with side walls and a bottom wall bounding a niche, said bottom wall having at least one slot formed therein and configured for draining the liquid from said insert downwards; and
a receptacle for receiving the liquid and or the free flow refrigerated good to be dispensed and disposed in said niche, said receptacle having a drip tray being separate from said insert for collecting the liquid and disposed in said niche, said drip tray having a drip well formed therein.

12. The household cooling appliance according to claim 11, wherein said slot extends in said bottom wall and upwards into one of said side walls adjacent to said bottom wall.

13. The household cooling appliance according to claim 12, wherein said slot in said bottom wall is one of a plurality of slots formed therein.

14. The household cooling appliance according to claim 11, wherein said slot narrows towards a front slot end, which faces away from one of said side walls ending in said bottom wall.

15. The household cooling appliance according to claim 11, wherein said slot is covered from said drip tray towards said niche.

16. The household cooling appliance according to claim 11, wherein said dispenser unit further includes:
a cover, which is separate from said insert, and is disposed in said niche, which covers said side walls at least partly in portions towards said niche, said cover having a front side facing said niche; and
at least one drain element disposed on said front side of said cover, which faces said niche, said drain element is configured to be elevated towards said niche and for draining the liquid running from said front side into said drip tray, said drain element is disposed in a height direction above said drip tray.

17. The household cooling appliance according to claim 12, wherein said slot in said bottom wall is one of four slots formed therein.
